(19) United States
(12) Patent Application Publication
(10) Pub. No.: US 2007/0195190 A1
(43) Pub. Date: Aug. 23, 2007

(54) Apparatus and method for determining in-focus position

(75) Inventor: Masahiko Sugimoto, Asaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/709,164

(22) Filed: Feb. 22, 2007

(30) Foreign Application Priority Data
Feb. 23, 2006 (JP) 046874/2006

(51) Int. Cl. G03B 13/00

(52) U.S. Cl. 348/345

(57) ABSTRACT

While driving means moves an imaging optical system from the near side to the far side, focus evaluation value calculation means calculates a focus evaluation value that changes with the movement, for causing maximum value detection means to detect a maximum value. At the same time, target detection means detects a predetermined target, and a position of the imaging optical system is obtained at the time of detection of the predetermined target near a position corresponding to the detected maximum value. An in-focus position is then determined according to the obtained position of the imaging optical system. In addition, the driving means stops the movement of the imaging optical system to the far side the vicinity of the position at which the target has been detected around the position corresponding to the maximum value.

### BACKGROUND OF THE INVENTION

1. Field of the Invention

The present invention relates to an apparatus and a method for determining an in-focus position for a photography apparatus such as a digital still camera having an automatic focus mechanism.

2. Description of the Related Art

Automatic focus (hereinafter referred to as AF) mechanisms, for focusing a photographing lens on a predetermined subject, are in wide use in photography apparatuses such as digital still cameras and digital camcorders. As such AF mechanisms, mechanisms that utilize an active method and mechanisms that utilize passive methods are known. In the active method, an infrared ray is emitted from a photography apparatus to a subject, and the distance to the subject is measured through detection of the angle of the ray returning to the apparatus after being reflected by the subject. The position of a photographing lens is set to focus on the subject at the measured distance. In the passive methods, a state of focus is detected by processing an image signal output from imaging means of a photography apparatus, and a photographing lens is set at a position realizing an optimal state of focus.

A phase detection method, wherein a state of focus is judged based on the amount of horizontal shift of the image of an object, and a contrast detection method, wherein a state of focus is judged based on the contrast of an image, are widely known as passive methods for use by AF mechanisms. In an AF mechanism adopting the contrast detection method, a photographing lens is driven in a stepwise manner within a movable range for focusing (such as mechanical ends from a near side to a far side), and image data are obtained from imaging means at each stepwise increment of motion. The photographing lens is set at a position corresponding to the maximum value of a focus evaluation value (a contrast value) of the image data.

As a passive method for use by AF mechanisms, a method is known wherein a skin-colored area representing a person is detected in an image signal output from imaging means. The detected skin colored area is designated as an AF area and a photographing lens is set at a position that enables an optimal state of focus in the AF area. Japanese Unexamined Patent Publication No. 11(1999)-146405 discloses an example of this method.

As in the technique disclosed in Japanese Unexamined Patent Publication No. 11(1999)-146405, a photographing lens is generally driven in a stepwise manner from a near side to a far side (or vice versa). At each step, image data are obtained from imaging means to detect a focus evaluation value, and a position corresponding to a maximum focus evaluation value is extracted. The photographing lens is then moved to the extracted position. In other words, the maximum focus evaluation value is detected after calculation of the focus evaluation values between the near side end and the far side end, and the photographing lens is moved to the position corresponding to the maximum evaluation value. Consequently, determination of in-focus positions has been time-consuming.

### SUMMARY OF THE INVENTION

The present invention has been conceived based on consideration of the above circumstances. An object of the present invention is therefore to provide an in-focus position determination apparatus and an in-focus position determination method that can determine an in-focus position in a short time.

An in-focus position determination apparatus of the present invention is an in-focus position determination apparatus having:

an imaging optical system for forming an image of a subject on a predetermined imaging surface;

driving means for moving the imaging optical system along an optical axis;

conversion means for converting the image of the subject having been formed into image data;

focus evaluation value calculation means for calculating a focus evaluation value based on the image data;

maximum value detection means for detecting a maximum value exceeding a predetermined threshold value in the calculated focus evaluation value; and

target detection means for detecting a predetermined target in the image data. The in-focus position determination apparatus determines an in-focus position of the imaging optical system in response to detection of the maximum value and the predetermined target, and the apparatus is characterized by further comprising:

control means for causing the driving means to move the imaging optical system from a near side to a far side while causing the maximum value detection means to detect the maximum value by causing the focus evaluation value calculation means to calculate the focus evaluation value that changes with movement of the imaging optical system and for causing at the same time the target detection means to detect the predetermined target to obtain the position of the imaging optical system at the time when the predetermined target is detected near a position corresponding to the detected maximum value; and

determination means for determining the in-focus position according to the obtained position of the imaging optical system. After the maximum value has been detected, the driving means stops the movement of the imaging optical system toward the far side.

Since the driving means stops the movement of the imaging optical system from the near side to the far side in the case where the predetermined target has been detected near the position corresponding to the detected maximum value, calculation of the focus evaluation value by the focus evaluation value calculation means is also stopped from the near side to the far side of the imaging optical system, in addition to stoppage of detection of the maximum value by the maximum value detection means and detection of the predetermined target in the image data by the target detection means.

After the position of the imaging optical system is beyond a predetermined position, the target detection means may cease detection of the predetermined target.

In addition, the focus evaluation value calculation means may comprise:

multi-point focus evaluation value calculation means for dividing a photography range represented by the image data into a plurality of areas and for calculating the focus evaluation value in each of the areas; and

center focus evaluation value calculation means for calculating the focus evaluation value in one area including the center of the photography range represented by the image data. In this case, the multi-point focus evaluation value calculation means may calculate the focus evaluation value in the case where a distance from the near side to a focal point position of the imaging optical system is a predetermined distance or less while the center focus evaluation value calculation means may calculate the focus evaluation value if otherwise.

The target detection means may detect a human face or an eye in the image data.

An in-focus position determination method of the present invention is an in-focus position determination method used in an in-focus position determination apparatus. The in-focus position determination apparatus comprises:

an imaging optical system for forming an image of a subject on a predetermined imaging surface;

driving means for moving the imaging optical system along an optical axis;

conversion means for converting the image of the subject having been formed into image data;

focus evaluation value calculation means for calculating a focus evaluation value based on the image data;

maximum value detection means for detecting a maximum value exceeding a predetermined threshold value in the calculated focus evaluation value; and

target detection means for detecting a predetermined target in the image data. The in-focus position determination apparatus determines an in-focus position of the imaging optical system in response to detection of the maximum value and the predetermined target, and the in-focus position determination method comprises the steps of:

causing the driving means to move the imaging optical system from the near side to the far side while causing the maximum value detection means to detect the maximum value by causing the focus evaluation value calculation means to calculate the focus evaluation value that changes with movement of the imaging optical system and causing at the same time the target detection means to detect the predetermined target to obtain the position of the imaging optical system at the time when the predetermined target is detected near a position corresponding to the detected maximum value;

determining the in-focus position according to the obtained position of the imaging optical system; and

causing the driving means to stop the movement of the imaging optical system toward the far side from the vicinity of the position of the imaging optical system.

Calculation of the focus evaluation value, the detection of the maximum value, and the face detection are carried out from the near side. The stepwise movement of the imaging optical system toward the far side is stopped after the in-focus position has been determined according to the position of the imaging optical system at the time of detection of the maximum value exceeding the threshold value and a face. Accordingly, the calculation of the focus evaluation value and the face detection are not carried out across the entire range of motion from the near side to the far side. Therefore, the in-focus position can be determined in a short time. In addition, in the case where the in-focus position is farther than the predetermined position, the face detection is not carried out but only the calculation of the focus evaluation value and the detection of the maximum value are carried out. In this manner, the number of steps necessary for determining the in-focus position can be reduced, leading to a shorter time for determination of the in-focus position for a subject at a far distance.

### BRIEF DESCRIPTION OF THE DRAWINGS

FIG. 1 is a rear view of a digital camera;

FIG. 2 is a frontal view of the digital camera;

FIG. 3 is a functional block diagram of the digital camera;

FIG. 4 is a flow chart showing the flow of processing carried out in the digital camera;

FIG. 5 is a flow chart showing the flow of processing in in-focus position determination processing;

FIG. 6 is a flow chart showing the flow of processing in rough search processing; and

FIGS. 7A to 7D show the in-focus position determination processing in detail.

### DESCRIPTION OF THE PREFERRED EMBODIMENT

Hereinafter, an embodiment of the present invention will be described with reference to the accompanying drawings. In the embodiment below, a digital camera will be described as an example of electronic equipment comprising an in-focus position determination apparatus of the present invention. However, the present invention can be applied not only to digital cameras but also other electronic equipment having an electronic imaging function, such as a digital camcorder, a camera phone, and a PDA with built in camera.

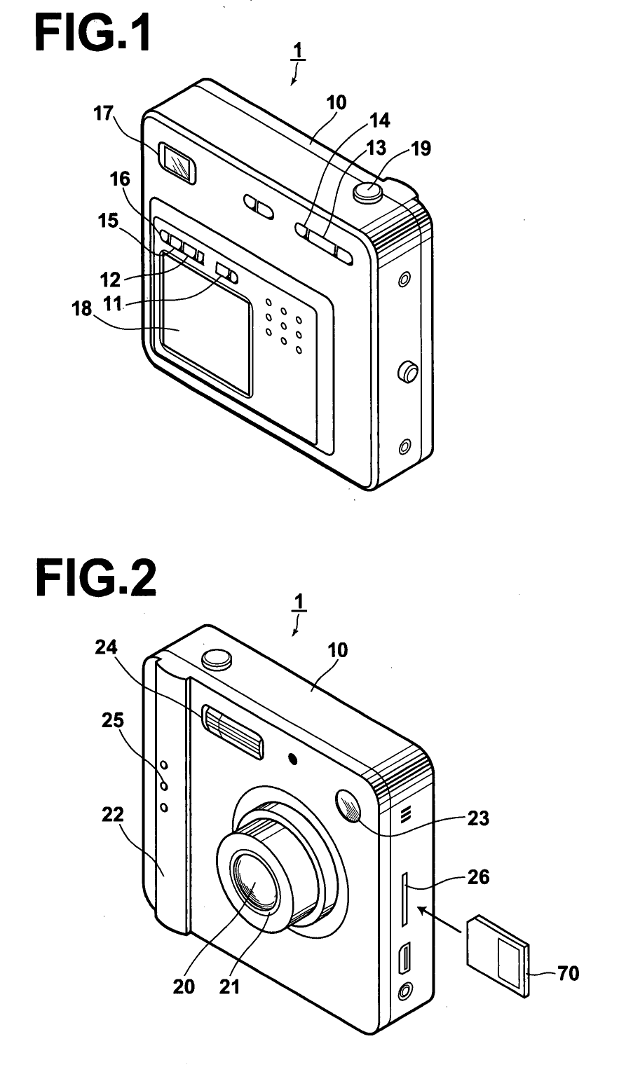

FIGS. 1 and 2 show an example of the digital camera viewed from the rear and from the front, respectively. As shown in FIG. 1, a digital camera 1 has an operation mode switch 11, a menu/OK button 12, a zoom/up-down lever 13, right-left buttons 14, a Back button 15, and a display change button 16, all of which serve as interfaces for operation by a photographer and are located at the rear of a body 10 thereof. In addition, the digital camera 1 has a viewfinder 17 for photography and a monitor 18 for photography and playback at the rear thereof, in addition to a shutter button 19 on the upper side thereof.

The operation mode switch 11 is a slide switch for changing operation mode between still image photography mode, moving image photography mode, and playback mode. By pressing the menu/OK button 12, various kinds of menus for setting photography mode, flash emission mode, the number of pixels to be recorded, sensitivity, etc. are displayed on the monitor 18. The menu/OK button is also used to confirm the setting or selection based on the menus displayed on the monitor 18.

When the zoom/up-down lever 13 is slid up or down during photography, zooming of the camera can be adjusted for tele-zoom or wide-zoom. When the lever 13 is slid up or down during input of various settings, a cursor in a menu screen displayed on the monitor 18 can be moved up or down. The right-left buttons 14 are used to move the cursor to the right and to the left in a menu screen displayed on the monitor 18 during input of various settings.

Pressing the Back button 15 stops a setting operation and displays an immediately preceding screen on the monitor 18. By pressing the display change button 16, the monitor 18 and display of various guides and characters thereon can be turned on and off. The viewfinder 17 is for a user to look in at the time of photography of a subject to check composition and focusing. An image of the subject in the viewfinder is displayed via a viewfinder window 23 on the front of the body 10

The contents of settings, input through operation of the buttons, the lever, and the switch, can be confirmed by display on the monitor 18, a lamp in the viewfinder, and the position of the slide lever, for example. The monitor 18 functions as an electronic viewfinder by displaying a throughput image for confirmation of the subject at the time of photography. The monitor 18 also displays a still image or a moving image, which is played back after photography, in addition to the various kinds of menus.

As shown in FIG. 2, the body 10 of the digital camera 1 has a photographing lens unit (an imaging optical system) 20, a lens cover 21, a power switch 22, the viewfinder window 23, a flash 24, and a self-timer lamp 25 located on the front thereof. A media slot 26 is also located on a side thereof.

The photographing lens unit 20 is for forming an image of the subject on a predetermined imaging surface (such as a CCD inside the body 10), and comprises a focus lens, a zoom lens, and the like. The lens cover 21 covers a surface of the photographing lens unit 20 to protect the photographing lens unit 20 from dirt, dust, or the like when the power of the digital camera 1 is off or when the digital camera 1 is in the playback mode, for example. The power switch 22 is for switching the digital camera 1 on and off. The flash 24 instantaneously emits light to the subject as necessary for photography thereof while the shutter button 19 is being pressed to open a shutter inside the body 10. The self-timer lamp 25 notifies the subject of the timing of opening/closing the shutter during photography using a self-timer. The media slot 26 is a slot for insertion of an external recording medium 70 such as a memory card. When the external recording medium 70 is inserted therein, data reading/writing is carried out.

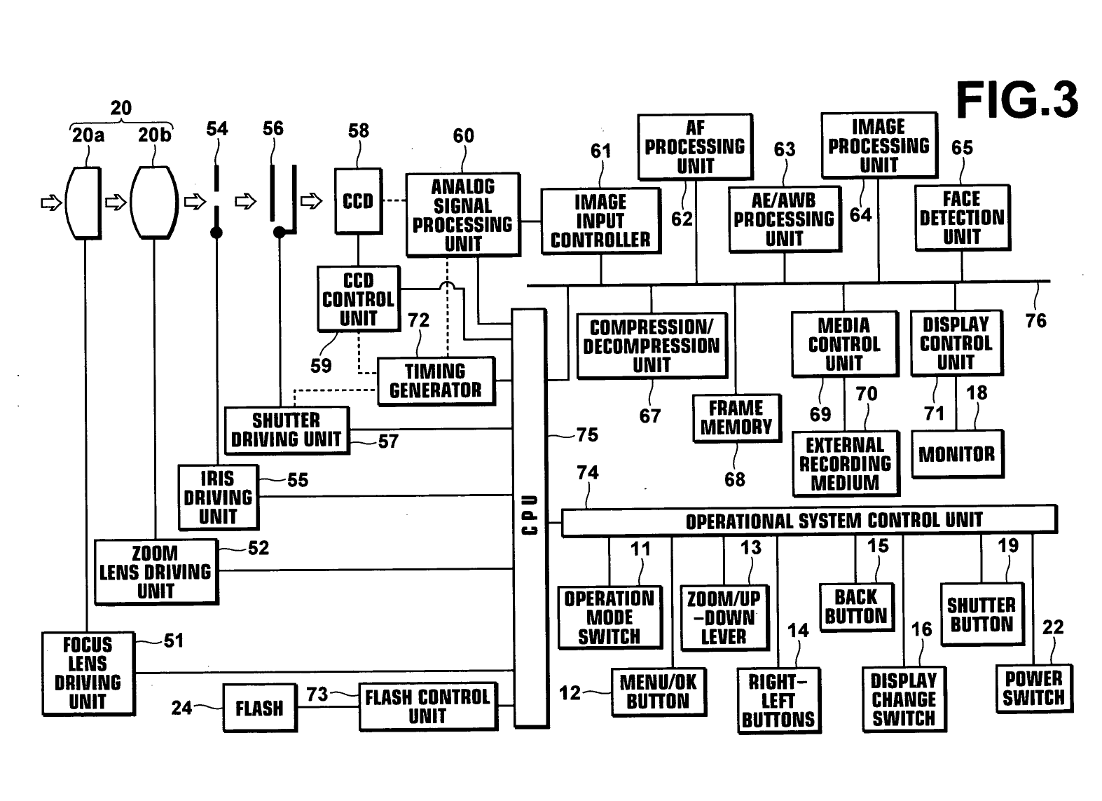

FIG. 3 is a block diagram showing the configuration of the digital camera 1 in terms of the functions thereof. The digital camera 1 has an operational system including the operation mode switch 11, the menu/OK button 12, the zoom/up-down lever 13, the right-left buttons 14, the Back button 15, the display change button 16, the shutter button 19, and the power switch 22 described above. In addition, an operational system control unit 74 that functions as an interface for sending the contents of operations to a CPU 75 is also included in the operating system.

The digital camera 1 also has a focus lens 20a and a zoom lens 20b that constitute the photographing lens unit 20. The lenses can be moved in stepwise increments along an optical axis by a focus lens driving unit (driving means) 51 and a zoom lens driving unit 52 each comprising a motor and a motor driver. The focus lens driving unit 51 and the zoom lens driving unit 52 control the stepwise movement of the corresponding lenses based on focus driving data output from an AF processing unit 62 and based on data representing operation of the zoom/up-down lever 13, respectively.

An iris 54 is driven by an iris driving unit 55 comprising a motor and a motor driver. The iris driving unit 55 adjusts a diameter of the iris 54 based on iris-value data output from an AE (Automatic Exposure) /AWB (Automatic White Balance) processing unit 63.

A shutter 56 is a mechanical shutter and driven by a shutter driving unit 57 comprising a motor and a motor driver. The shutter driving unit 57 opens and closes the shutter 56 according to a signal generated by pressing the shutter button 19 down and according to shutter speed data output from the AE/AWB processing unit 63.

A CCD 58 (conversion means) as an imaging device is located at the rear of the optical system. The CCD 58 has a photoelectric surface whereon a plurality of photoreceptor elements are arranged two-dimensionally. Light from the subject passing through the optical system forms an image on the surface and is subjected to photoelectric conversion. A micro-lens array (not shown) for focusing the light on each pixel and a color filter array (not shown), wherein filters for R, G, and B colors are arranged regularly, are located in front of the photoelectric surface. The CCD 58 outputs an electric charge stored at each of the pixels as serial analog image data for each line while synchronizing with a vertical transfer clock signal and a horizontal transfer clock signal supplied from a CCD control unit 59. The time during which the electric charge is stored at each of the pixels, that is, an exposure time is determined by an electronic shutter driving signal output from the CCD control unit 59.

The analog image data from the CCD 58 are input to an analog signal processing unit 60. The analog signal processing unit 60 comprises a correlated double sampling (CDS) circuit for removing noise from the analog image signal, an automatic gain controller (AGC) for adjusting a gain of the analog image signal, and an A/D converter (ADC) for converting the analog image data into digital image data. The digital image data are CCD-RAW data having density values of R, G, and B for each of the pixels.

A timing generator 72 generates a timing signal. Feeding of the timing signal to the shutter driving unit 57, the CCD control unit 59, and the analog signal processing unit 60 synchronizes operation of the shutter button 19, the opening/closing of the shutter 56, input of the electric charge of the CCD 58, and processing by the analog signal processing unit 60. A flash control unit 73 controls light emission from the flash 24.

An image input controller 61 writes the CCD-RAW data input from the analog signal processing unit 60 in a frame memory 68. The frame memory 68 is a memory used as workspace for various kinds of digital image processing (signal processing) on the image data that will be described later, and comprises an SDRAM (Synchronous Dynamic Random Access Memory) that carries out data transfer in synchronization with a bus clock signal of a predetermined period, for example.

A display control unit 71 is used to display the image data stored in the frame memory 68 as the throughput image on the monitor 18. The display control unit 71 converts a luminance (Y) signal and a color (C) signal into one composite signal, and outputs the composite signal to the monitor 18. The throughput image is obtained at predetermined intervals and displayed on the monitor 18 when the photography mode is on. The display control unit 71 also displays an image on the monitor 18, based on the image data stored in the frame memory 68 or image data stored in an image file in the external recording medium 70 and read by a media control unit 69.

The AF processing unit (focus evaluation value calculation means, maximum value detection means, determination means, multi-point focus evaluation value calculation means, and center focus evaluation value calculation means) 62 and the AE/AWB processing unit 63 determine photography conditions based on a preliminary image. The preliminary image is an image represented by the image data stored in the frame memory 68 as a result of preliminary photography carried out by the CCD 58 instructed by the CPU 75 that has detected a half-press signal generated by half press of the shutter button 19.

The AE processing unit 62 detects a focal point position based on the preliminary image, and outputs the focus driving data. A passive method utilizing a characteristic that a focus evaluation value becomes larger in an in-focus state is adopted as a method for detecting the focal point position.

The AE/AWB processing unit 63 measures luminance of the subject based on the preliminary image, and determines an iris value, a shutter speed, and the like based on the luminance. The AE/AWB processing unit then outputs the data of the iris value and the shutter speed (AE processing), and adjusts white balance at the time of photography (AWB processing).

An image processing unit 64 carries out image quality enhancement processing such as Gamma correction, sharpness correction, and contrast correction on data of a final image. The image processing unit 64 also carries out YC processing to convert the CCD-RAW data into YC data comprising Y data as a luminance signal, Cb data as a blue color difference signal, and Cr data as a red color difference signal. The final image is an image based on the image data stored in the frame memory 68 via the analog signal processing unit 60 and the image input controller 61 after input of the analog image data from the CCD 58 in response to full press of the shutter button 19. The maximum number of pixels of the final image is determined by the number of the pixels of the CCD 58. However, the number of pixels to be recorded can be changed by the user, by setting the image quality to fine or normal, for example. The number of pixels of the throughput image and the preliminary image may be smaller than that of the final image, and may be 1/16 that of the final image, for example.

A face detection unit 65 is for detecting a human face or an eye in the image data stored in the frame memory 68. In this embodiment, the face detection unit 65 detects a human face. However, a human eye or an animal face or eye may be detected, for example.

A compression/decompression unit 67 carries out compression processing in a format such as JPEG on the image data having been subjected to the image enhancement processing and the like by the image processing unit 64, and generates an image file. Accompanying information is added to the image file according to the data format. The compression/decompression unit 67 also reads a compressed image file from the external recording medium 70 in the playback mode, and carries out decompression processing thereon. Image data, on which the decompression processing has been administered, are output to the display control unit 71, and the display control unit 71 displays an image based on the image data on the monitor 18.

The media control unit 69 corresponds to the media slot 26 shown in FIG. 2, and carries out image-file reading and writing on the external recording medium 70.

The CPU 75 controls each of the units of the digital camera 1 in response to operation of the buttons, the lever, and the switches as well as signals from the respective functional blocks. A data bus 76 for exchanging the various kinds of signals and data is connected to the image input controller 61, the various kinds of processing units 62 to 67, the frame memory 68, the control units 69 and 71, and the CPU 75,.

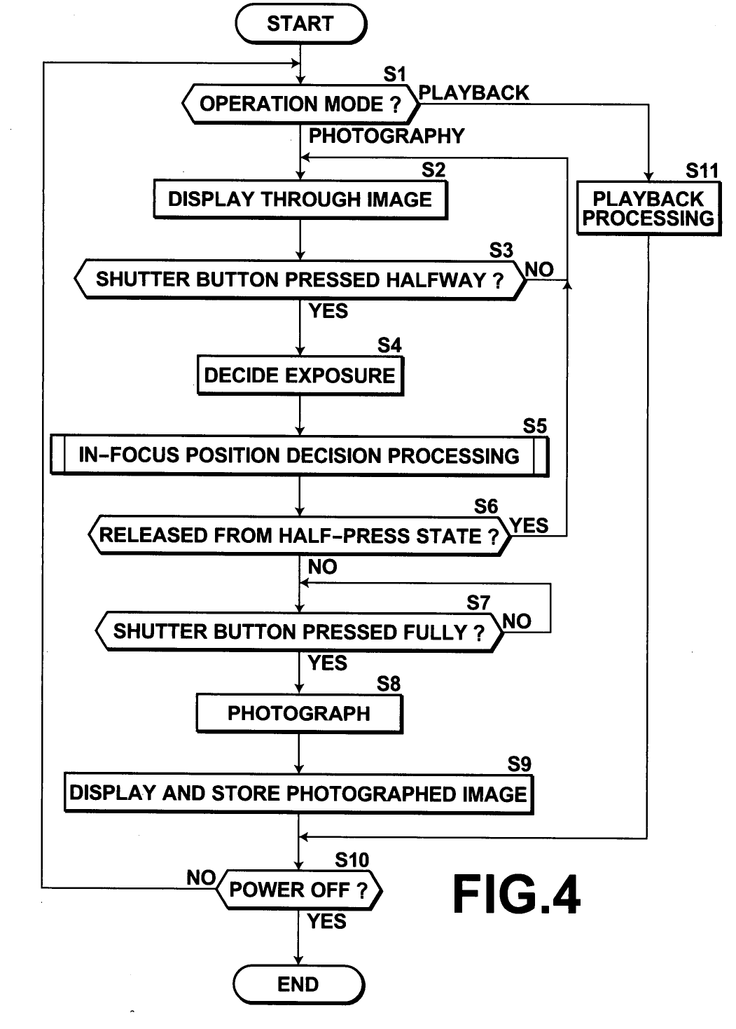

The flow of processing carried out in the digital camera 1 will be described next with reference to the flow chart shown in FIG. 4. The CPU 75 firstly judges whether the operation mode is the photography mode or the playback mode based on how the operation mode switch 11 has been set (Step S1). In the case where the operation mode is the playback mode (Step S1; PLAYBACK), playback processing is carried out (Step S11). In the playback processing, the media control unit 69 reads an image file stored in the external recording medium 70 and displays an image based on image data in the image file on the monitor 18. After completion of the playback processing, the CPU 75 judges whether operation of the power switch 22 has been carried out to switch the digital camera 1 off (Step S10). If the result at Step S10 is affirmative (Step S10; YES), the digital camera 1 is switched off to end the flow of processing.

In the case where the operation mode has been judged to be the photography mode at Step S1 (Step S1; PHOTOGRAPHY), the CPU 75 carries out throughput image display control (Step S2). Throughput image display refers to display of the preliminary image on the monitor 18. The CPU 75 then judges whether the shutter button 19 has been pressed halfway (Step S3). In the case where the result at Step S3 is negative (Step S3; NO), the CPU 75 repeats the procedure at Step S2. If the result at Step S3 is affirmative (Step S3; YES), the AE/AWB processing unit 63 determines exposure (Step S4).

In-focus position determination processing is then carried out (Step S5). The in-focus position determination processing will be described later in detail. After the in-focus position determination processing, whether the shutter button 19 has been released from the half-pressed state is judged (Step S6). If the result at Step S6 is affirmative (Step S6; YES), the CPU 75 returns the flow of processing to Step S2. If the result at Step S6 is negative (Step S6; NO), the CPU 75 judges whether the shutter button 19 has been pressed fully (Step S7). If the result at Step S7 is negative (Step S7; NO), the procedure at Step S7 is repeated. If the result at Step S7 is affirmative (Step S7; YES), the CPU 75 carries out photography processing (Step S8). The photography processing refers to the processing wherein analog image data based on an image of a subject formed on the photoelectric surface of the CCD 58 are subjected to the A/D conversion followed by the various kinds of signal processing by the image processing unit 64. In the photography processing, the image data having been subjected to the signal processing may be subjected to compression processing by the compression/decompression unit 67 to generate an image file.

After the photography processing, the CPU 75 carries out processing to display the photographed image on the monitor 18, and records the image in the external recording medium 70 (Step S9). The CPU 75 then judges whether operation of the power switch 22 has been carried out to switch the digital camera 1 off (Step S10). If the result at Step S10 is affirmative (Step S10; YES), the CPU 75 switches the power of the digital camera 1 off to end the flow of processing. If the result at Step S10 is negative (Step S10; NO), the CPU 75 returns the flow of processing to Step S1.

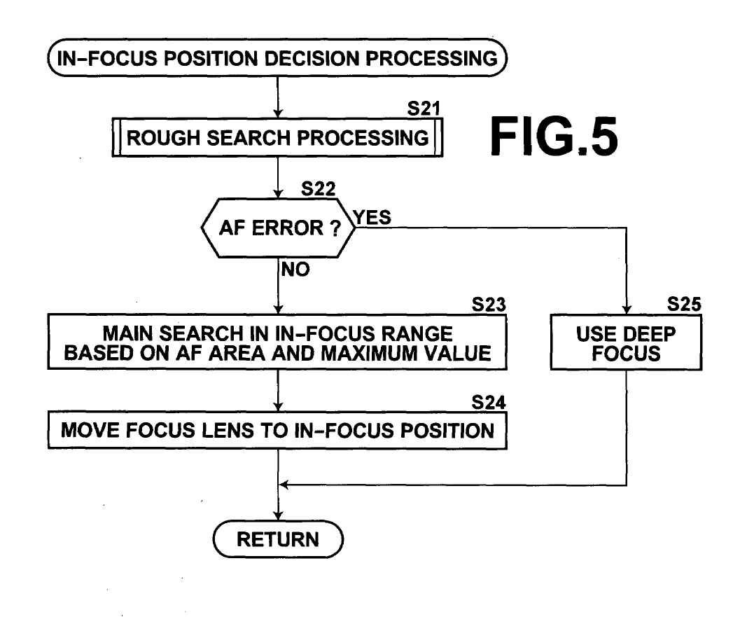

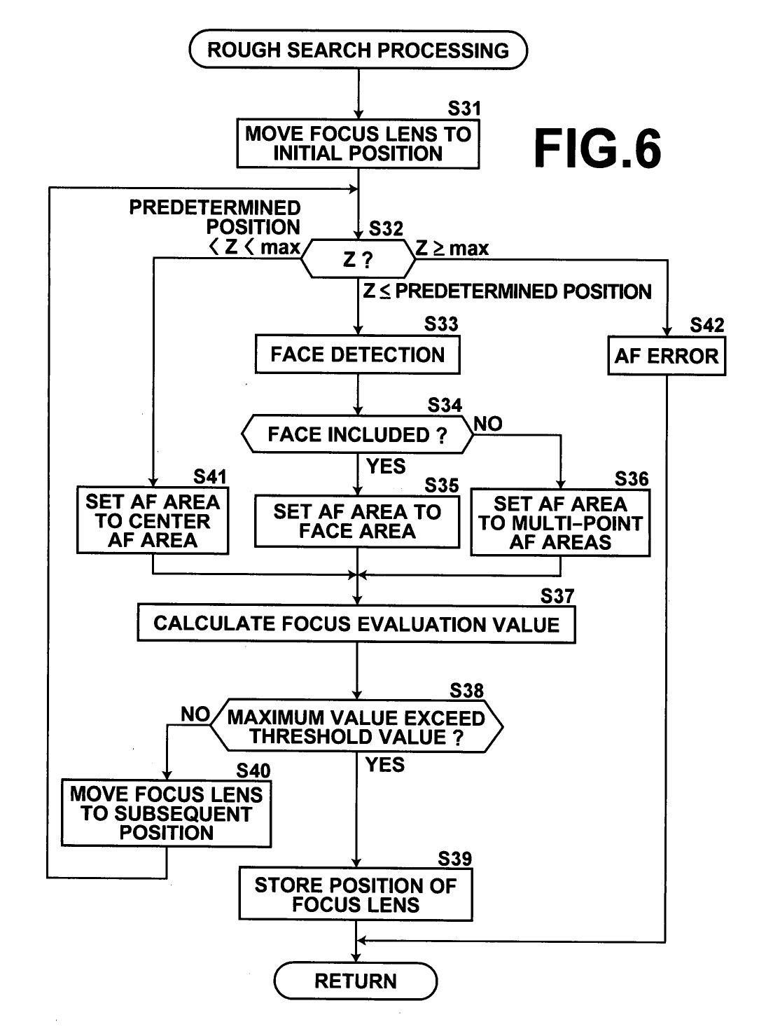

The flow of processing in the in-focus position determination processing will be described next, with reference to the flow chart shown in FIG. 5. The CPU 75 carries out rough search processing (Step S21). FIG. 6 is a flow chart showing the flow of processing therein. The CPU 75 firstly outputs a command signal to the focus lens driving unit 51 (Step S31) to move the focus lens 20a to an initial position (the near side). The focal point position of the focus lens 20a is designated as Z. In the case where the position Z is at a predetermined position or closer to the near side (Step S32; Z≦PREDETERMINED POSITION), the CPU 75 detects a human face in the image data stored in the frame memory 68 (Step S33).

In the case where a human face has been detected (Step S34; YES), the CPU 75 sets an AF area to an area including the detected face (Step S35). In the case where no face has been detected (Step S34; NO), the CPU 75 sets the AF area to multi-point AF areas (Step S36). The CPU 75 calculates the focus evaluation value for each of the set areas (Step S37), and carries out detection of a maximum value exceeding a threshold value in the calculated focus evaluation values (Step S38). In the case where a maximum value exceeding the threshold value exists (Step S38; YES), the CPU 75 stores the current position of the focus lens 20a as an assumed in-focus position thereof (Step S39) to end the rough search processing. If the result at Step S38 is negative, (Step S38; NO), the CPU 75 outputs a command signal to the focus lens driving unit 51 to move the focus lens 20a to a next stepwise position in the range of motion thereof (Step S40).

In the case where the position Z is farther than the predetermined position but not beyond the end of the far side (max) at Step S32 (Step S32; PREDETERMINED POSITION<Z<max), the CPU 75 sets the AF area to a center AF area (Step S41), and calculates the focus evaluation value in the set AF area (Step S37). The CPU 75 carries out detection of a maximum value exceeding the threshold value in the calculated focus evaluation values (Step S38). If a maximum value exceeding the threshold value exists (Step S38; YES), the CPU 75 stores the current position of the focus lens 20a as an assumed in-focus position (Step S39) to end the rough search processing. Otherwise (Step S38; NO), the CPU 75 outputs a command signal to the focus lens driving unit 51 to move the focus lens 20a to a next stepwise position in the range of motion thereof (Step S40).

In the case where the position Z is at the end of the far side or beyond at Step S32 (Step S32; Z>max), the CPU 75 judges that an AF error has occurred (Step S42) to end the rough search processing.

The CPU 75 then judges whether the AF error has been found in the rough search processing at Step S22 in FIG. 5. In the case of no AF error (Step S22; NO), the CPU 75 carries out final search processing in a predetermined range including the assumed in-focus position of the focus lens 20a stored in the rough search processing (Step S23). The final search processing is processing for finding the in-focus position, and the focus evaluation value is calculated at every movement of the focus lens 20a in the range to detect the maximum value. The CPU 75 moves the focus lens 20a to the position corresponding to the detected maximum value (Step S24) to end the in-focus position determination processing. In the case where an AF error has been found in the rough search processing (Step S22; YES), the CPU 75 uses deep focus, and moves the focus lens 20a to the corresponding position (Step S25) to end the in-focus position determination processing.

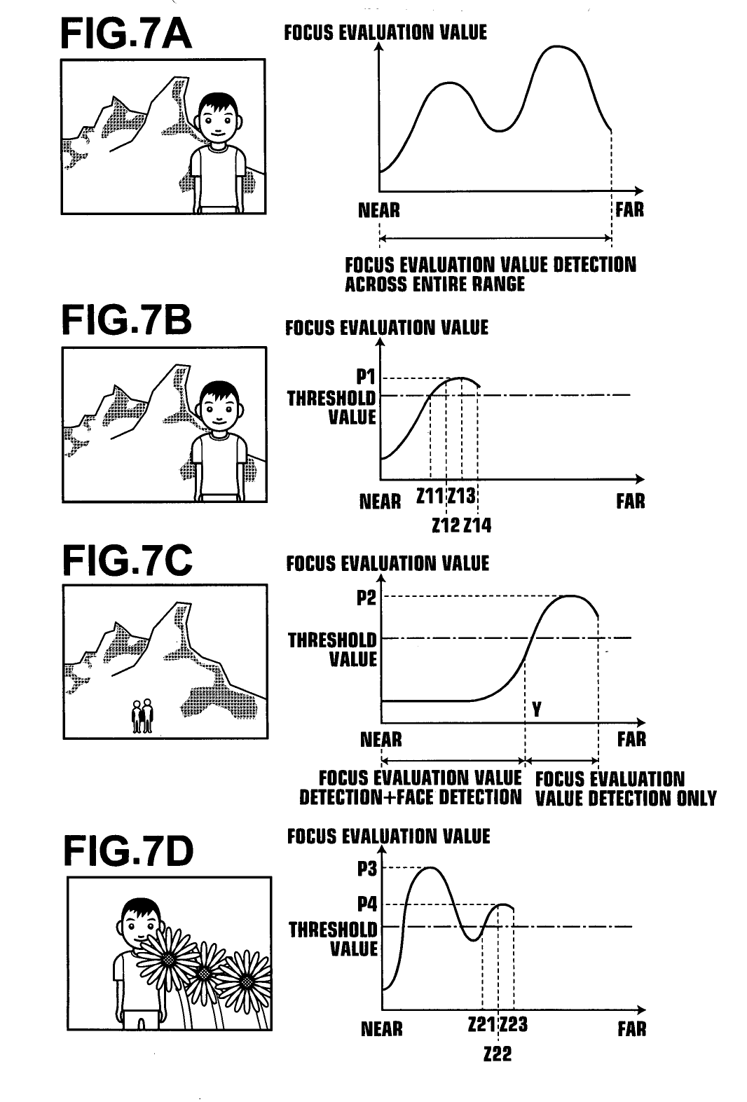

The in-focus position determination processing will be described in detail with reference to FIGS. 7A to 7D. FIG. 7A shows a conventional method of in-focus position determination. The images on the left of FIGS. 7A to 7D show images of subjects formed on the imaging surface of the CCD 58, and graphs on the right show relationships between the focus evaluation value in the vertical axes and ranges in the horizontal axes from the near side toward the far side wherein the focus evaluation value is calculated. As shown in FIG. 7A, the focus lens 20a is conventionally moved in a stepwise manner across the entire range from the near side to the far side to calculate the focus evaluation value at every step. After the calculation of the focus evaluation value in the entire range, the maximum value of the focus evaluation value is detected. Based on the detected maximum value and the result of detection of a face, an eye or the like, the in-focus position is determined in the final search processing. Therefore, even in the case where a subject such as a person is in focus in the near side, the calculation of the focus evaluation value is carried out to the far side, which lengthens the time necessary for in-focus position determination.

FIGS. 7B to 7D show the in-focus position determination method of the present invention. FIG. 7B shows a case where a person is in focus in the near side. As shown in FIG. 7B, the focus lens 20a is moved from the near side while the calculation of the focus evaluation value is carried out simultaneously with face detection. In the case where the face has been detected at positions Z11 to Z14 and a maximum value P1 (a peak corresponding to the face) exceeding the threshold value has been detected, the rough search processing ends. The final search processing is then carried out by moving the focus lens 20a to the predetermined range including the maximum value P1 (such as the range from Z11 to Z14) to determine the in-focus position. By calculating the focus evaluation value from the near side simultaneously with face detection and by carrying out the final search processing after ending the rough search processing in the case where a maximum value exceeding the threshold value as well as a face have been detected, the time necessary for the in-focus position determination can be shortened.

FIG. 7C shows a case where people and the like are not near but at a far distance or a case where scenery or a landmark at a far distance is photographed. In the case where the focal point position of the focus lens 20a is between the end in the near side and a predetermined position Y, the focus evaluation value is calculated at every step of movement thereof to carry out the maximum value detection and the face detection. In the case where the focal point position of the focus lens 20a is in the far side beyond the predetermined position Y, the calculation of the focus evaluation value and the maximum value detection are carried out without the face detection. When a maximum value P2 (a peak corresponding to the mountain) is detected, the final search processing is carried out in a predetermined range including the maximum value P2, for in-focus position determination. The faces of the people at a far distance are highly likely the faces of passers-by, instead of people to be photographed. Therefore, the face detection is not carried out after the in-focus position is in the far side beyond the predetermined position Y. By carrying out only the focus evaluation value calculation and the maximum value detection, the number of steps necessary for processing is reduced, which leads to faster determination of the in-focus position.

FIG. 7D shows a case where objects such as flowers are at a near distance and a subject such as a person is behind the objects. The focus evaluation value is calculated while the focus lens 20a is moved from the near side. In the case where a maximum value P3 (a peak corresponding to the flowers) has been detected but no face has been detected, the movement of the focus lens 20a and the calculation of the focus evaluation value are continued, since the objects at the position corresponding to the maximum value P3 are judged to not be a person. Thereafter, in the case where a face has been detected at positions Z21 to Z23 and a maximum value P4 exceeding the threshold value (a peak corresponding to the face) has been detected, the rough search processing ends. The final search processing is then carried out by moving the focus lens 20a in a predetermined range including the maximum value P4 (such as the range from Z21 to Z23), to determine the in-focus position.

As has been described above, by carrying out the calculation of the focus evaluation value from the near side at the same time of the maximum value detection as well as the face detection and by carrying out the final search processing after completion of the rough search processing in the case where a maximum value exceeding the threshold value and a face have been detected, the in-focus position can be determined in a short time. In the case where the in-focus position is in the far side beyond the predetermined position, only the calculation of the focus evaluation value and the maximum value detection are carried out without the face detection. Therefore, the number of steps necessary for determining the in-focus position can be reduced, which leads to a shorter time necessary for determining the in-focus position at the time of photography of a subject at a far distance.

What is claimed is:

1. An in-focus position determination apparatus having:
an imaging optical system for forming an image of a subject on a predetermined imaging surface;
driving means for moving the imaging optical system along an optical axis;
conversion means for converting the image of the subject having been formed into image data;
focus evaluation value calculation means for calculating a focus evaluation value based on the image data;
maximum value detection means for detecting a maximum value exceeding a predetermined threshold value in the calculated focus evaluation value; and
target detection means for detecting a predetermined target in the image data, the in-focus position determination apparatus determining an in-focus position of the imaging optical system in response to detection of the maximum value and the predetermined target, the in-focus position determination apparatus further comprising:
control means for causing the driving means to move the imaging optical system from the near side to the far side while causing the maximum value detection means to detect the maximum value by causing the focus evaluation value calculation means to calculate the focus evaluation value changing with movement of the imaging optical system and for causing at the same time the target detection means to detect the predetermined target to obtain the position of the imaging optical system at the time when the predetermined target is detected near a position corresponding to the detected maximum value; and
determination means for determining the in-focus position according to the obtained position of the imaging optical system, wherein
the driving means stops the movement of the imaging optical system to the far side after the maximum value has been detected.

2. The in-focus position determination apparatus according to claim 1, wherein the target detection means does not detect the predetermined target after a position of the imaging optical system is beyond a predetermined position.

3. The in-focus position determination apparatus according to claim 1, the focus evaluation value calculation means comprising:
multi-point focus evaluation value calculation means for dividing a photography range represented by the image data into a plurality of areas and for calculating the focus evaluation value in each of the areas; and
center focus evaluation value calculation means for calculating the focus evaluation value in one area including the center of the photography range represented by the image data, wherein
the multi-point focus evaluation value calculation means calculates the focus evaluation value in the case where a distance from the near side to a focal point position of the imaging optical system is a predetermined distance or under while the center focus evaluation value calculation means calculates the focus evaluation value in the case where the distance is longer than the predetermined distance.

4. The in-focus position determination apparatus according to claim 2, the focus evaluation value calculation means comprising:
multi-point focus evaluation value calculation means for dividing a photography range represented by the image data into a plurality of areas and for calculating the focus evaluation value in each of the areas; and
center focus evaluation value calculation means for calculating the focus evaluation value in one area including the center of the photography range represented by the image data, wherein
the multi-point focus evaluation value calculation means calculates the focus evaluation value in the case where a distance from the near side to a focal point position of the imaging optical system is a predetermined distance or under while the center focus evaluation value calculation means calculates the focus evaluation value in the case where the distance is longer than the predetermined distance.

5. The in-focus position determination apparatus according to claim 1 wherein the target detection means detects a human face or an eye in the image data.

6. The in-focus position determination apparatus according to claim 2 wherein the target detection means detects a human face or an eye in the image data.

7. The in-focus position determination apparatus according to claim 3 wherein the target detection means detects a human face or an eye in the image data.

8. The in-focus position determination apparatus according to claim 4 wherein the target detection means detects a human face or an eye in the image data.

9. An in-focus position determination method used in an in-focus position determination apparatus, the in-focus position determination apparatus comprising:
an imaging optical system for forming an image of a subject on a predetermined imaging surface;
driving means for moving the imaging optical system along an optical axis;
conversion means for converting the image of the subject having been formed into image data;
focus evaluation value calculation means for calculating a focus evaluation value based on the image data;
maximum value detection means for detecting a maximum value exceeding a predetermined threshold value in the calculated focus evaluation value; and
target detection means for detecting a predetermined target in the image data, the in-focus position determination apparatus determining an in-focus position of the imaging optical system in response to detection of the maximum value and the predetermined target, the in-focus position determination method comprising the steps of:
causing the driving means to move the imaging optical system from the near side to the far side while causing the maximum value detection means to detect the maximum value by causing the focus evaluation value calculation means to calculate the focus evaluation value changing with movement of the imaging optical system and causing at the same time the target detection means to detect the predetermined target to obtain the position of the imaging optical system at the time when the predetermined target is detected near a position corresponding to the detected maximum value;
determining the in-focus position according to the obtained position of the imaging optical system; and
causing the driving means to stop the movement of the imaging optical system toward the far side from the vicinity of the position of the imaging optical system.
